(19) United States
(12) Patent Application Publication
(10) Pub. No.: US 2005/0230960 A1
(43) Pub. Date: Oct. 20, 2005

(54) Security label, secured article and method for making the label and article

(76) Inventors: Wayne Louis Bilodeau, Mentor, OH (US); Patrick M. Goss, Chardon, OH (US); James A. Macuga, Concord, OH (US)

Correspondence Address: RENNER, OTTO, BOISSELLE & SKLAP, LLP, 1621 EUCLID AVE, 19TH FL, CLEVELAND, OH, 44115-2191, US

(21) Appl. No.: 11/067,804

(22) Filed: Feb. 28, 2005

Related U.S. Application Data
(60) Provisional application No. 60/557,313, filed on Mar. 29, 2004.

(51) Int. Cl. G09C 3/00

(52) U.S. Cl. 283/75

(57) ABSTRACT

A tamper-resistant secure label, article and associated method. A label for overlying information comprises an adhesive layer for adhering the label to a substrate. The adhesive layer includes a structural adhesive that ensures that an initial removal precludes re-adhering using the adhesive layer. The label may further include an obscuring layer to selectively block visual access to the information and maintain the confidentiality of the information until the obscuring layer is removed.

This application claims the benefit of provisional application Ser. No. 60/557,313 filed on Mar. 29, 2004, which is hereby incorporated herein by reference in its entirety.

### FIELD OF THE INVENTION

The present invention relates generally to a security label, secured article and a method of producing the label and article. In particular, the present invention relates to a label for application over information that reduces, prevents and/or evidences tampering, and to a label for use with confidential information having an obscuring layer to reduce, prevent and/or evidence tampering.

### BACKGROUND OF THE INVENTION

Confidential information can be printed or laminated onto commercially available debit cards, prepaid telephone cards and lottery tickets. The information can be, for example, a personal identification number (PIN) on the debit card, an activation code on the telephone card, or win/lose indicia on the lottery ticket. Unfortunately, the information, that is, the value of the item, may be stolen if the confidential nature of the information is not protected.

Current techniques exist that attempt to protect the confidential nature of the information until it is delivered to an intended user or consumer, but these techniques can be insufficient, economically impractical, problematic to implement, or too easily circumventable. For example, on a conventional telephone card the activation code is obscured or hidden from view by an opaque scratch-off layer that is adhered to a wallet-sized card. In operation, the consumer purchases the card, scratches off the opaque layer and reveals the activation code for his or her own use.

However, in the above-referenced example, the protection technique is often circumvented; information taken by an unauthorized person and the value of the information improperly used. Further, the information can be taken in such a manner that the theft of the information is not immediately detectable. A legitimate purchaser or consumer may obtain subsequent possession of the information only to discover that they have purchased a used card where the information no longer has value. In this example, the scratch-off layer had been adhered to the card using a pressure sensitive adhesive, the unauthorized person or thief froze the pressure sensitive adhesive (rendering the pressure sensitive adhesive temporarily non-adhesive) to peel back the opaque scratch-off layer without damage to the scratch-off layer. The information, such as the activation code, was stolen and the scratch-off layer was replaced. The pressure sensitive adhesive returned to room temperature and regained its tacky, adhesive qualities. The activation code was then used and valueless, but the card appeared to be pristine to the unsuspecting subsequent consumer.

In the automotive manufacturing industry, for example, industrial fabrication techniques have been developed for use in various bonding applications, such as “hem-flange” bonding. Dual cured adhesive systems have been used to provide an adhesive having an initial tackiness and a subsequent increased peel adhesion and high temperature shear performance. Pressure sensitive structural adhesives have been used to provide an initially tacky surface, which, when cured, change bond properties from removably tacky to a permanent structural bond. Such systems are disclosed in U.S. Pat. Nos. 5,723,191 and 5,593,759, commonly assigned to Avery Dennison Corporation (Pasadena, Calif.), which are hereby incorporated by reference in their entirety.

It would be desirable to provide tamper resistant articles and methods. The tamper resistant articles would aid in the protection of the confidential nature of information until it is delivered to an intended user or consumer. Tamper resistance can include such properties as the ability to defeat theft schemes, for example, the freezing scheme disclosed hereinabove, and/or the ability to evidence that such a theft has occurred. By evidencing that a tampering has occurred, a subsequent consumer would be protected from purchasing an item for which the value has been previously used.

### SUMMARY OF THE INVENTION

The present invention provides a security label, a secured article for increasing tamper resistance and an associated method. An embodiment according to a first aspect of the invention includes a label that can overlay confidential information, and selectively block access to that confidential information during use. In particular, the label may include an obscuring layer operable to overlay the confidential information to hide or maintain the confidential nature of the confidential information until the obscuring layer is removed.

An embodiment according to a second aspect of the invention includes a label that can overlay information and block or reduce access to the information while maintaining viewing access to the information. In particular, the second aspect label includes a film that may be transparent, that is, through which the information may be viewed, but may not be physically accessed or altered.

The labels of both the first and second aspects include an adhesive layer that can adhere to a substrate to form the secure article. The adhesive layer may include a structural adhesive. The presence of the structural adhesive ensures that an initial removal of the adhesive layer from a surface, for example, precludes re-adherence using the adhesive layer.

The adhesive layer can further have initial pressure sensitive adhesive properties. The pressure sensitive adhesive properties allow for a general ease-of-application or ease-of-manufacture such that a film or layer can be mounted on the substrate and initially held by the pressure sensitive adhesive properties. The structural adhesive properties form subsequent to initial application and permanently or strongly adhere the film or layer to the substrate.

The initial pressure sensitive adhesive properties and the subsequent structural adhesive properties can be obtained in accordance with an embodiment of the present invention by admixing a pressure sensitive adhesive with a structural adhesive to form a dual adhesive system. The system is initially a pressure sensitive adhesive with a latent structural adhesive, and through a predetermined method, the structural adhesive properties are realized.

In one embodiment, the latent structural adhesive is an anaerobically curable or cured adhesive. A transition metal compound, for example, organocopper ions can be used to initiate a switch from a latent state to a cured state in the anaerobic environment. In alternative embodiments, rather than using two different adhesives, a single adhesive with a dual cure system can be used. In yet other embodiments, an article can also include the substrate itself and/or additional layers, such as print layers, tie layers, and the like.

The presence of structural adhesive properties increases the tamper resistance and/or tamper evidencing properties of an article in accordance with the invention. Access to information, use of an embossed seal, and maintaining or protecting the confidential nature of information until accessed by the rightful consumer is controlled. Tampering, fraud and the like can be reduced or minimized. Alternatively, if tampering occurs, tampering is evident and the consumer or user is forewarned of such tampering.

### BRIEF DESCRIPTION OF THE DRAWINGS

FIG. 1 is an exploded schematic cross-sectional side view of a label comprising an embodiment in accordance with a first aspect of the present invention;

FIG. 2 is a top perspective view of an article comprising another embodiment in accordance with the present invention;

FIG. 3 shows a cross-sectional side view of the article of FIG. 2 taken along the line 3-3;

FIGS. 4-6 show cross-sectional side views of other articles, each comprising an alternative embodiment in accordance with the present invention and taken along a line similar to the view shown in FIG. 3;

FIGS. 7(a)-7(e) show cross-sectional side views of secure labels comprising alternative embodiments according to the present invention; and

FIG. 8 is a schematic perspective view of an article comprising embodiments according to a second aspect of the present invention.

### DESCRIPTION OF EMBODIMENTS

The present invention is directed to a security label comprising: a protecting layer having an upper surface and a lower surface; and an adhesive layer having an upper surface and a lower surface, wherein the upper surface is adhered to the lower surface of the protecting layer and wherein upon application of the label to a substrate, the adhesive layer initially adheres to the substrate in response to light pressure and subsequently adheres to the substrate with a bond strength equal to or greater than the cohesive strength of the substrate or adhesive layer.

The present invention is further directed to a secured article comprising: a label comprising a protecting layer having an upper surface and a lower surface; and an adhesive layer having an upper surface and a lower surface, wherein the upper surface of the adhesive layer is adhered to the lower surface of the protecting layer; a secured information layer underlying the protecting layer; a substrate having an upper surface; wherein upon application of the label to the substrate, the adhesive layer initially adheres to the substrate in response to light pressure and subsequently adheres to the substrate with a bond strength equal to or greater than the cohesive strength of the substrate or adhesive layer.

In a first aspect of the invention, an obscuring layer is used to overlay confidential information. The obscuring layer can maintain the confidential nature of the confidential information until such time as the obscuring layer is removed. The removal of the obscuring layer may evidence that the information has been accessed or tampered with, and the confidential nature of the information may have been compromised. In a second aspect of the invention, a transparent layer is used to reduce or prevent access to or alteration of information underlying the transparent layer. However, the information may be viewed through the transparent layer.

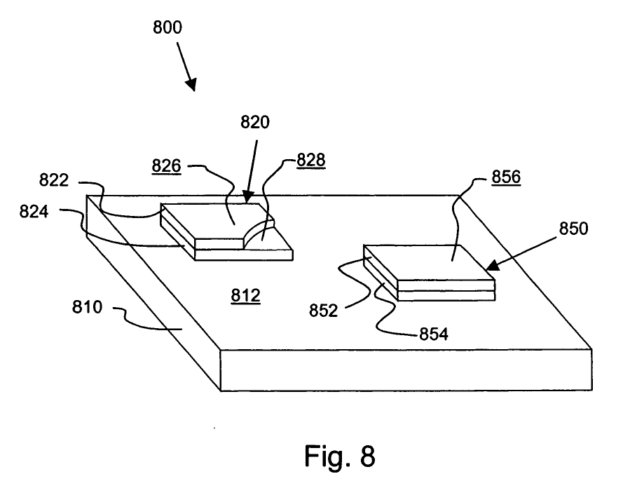

Embodiments relating to both the first and second aspects provide generally a secure label, article and an associated method for making the secure labels and articles. The secure label has a structural adhesive that permanently adheres an obscuring layer to a substrate. During use, the structural adhesive provides increased peel strength. After application to the substrate, the structural adhesive may no longer be tacky and cannot re-adhere. Embodiments relating to the second aspect are discussed further hereinbelow with reference to FIG. 8. Embodiments having an obscuring layer are addressed first.

A tamper resistant secure label, article and system having an obscuring layer may be suitable for use in applications having confidential information associated therewith, such as pre-paid telephone calling cards, debit cards, lottery tickets, bank checks, security instruments, and documents having confidential information, original signatures and the like thereon.

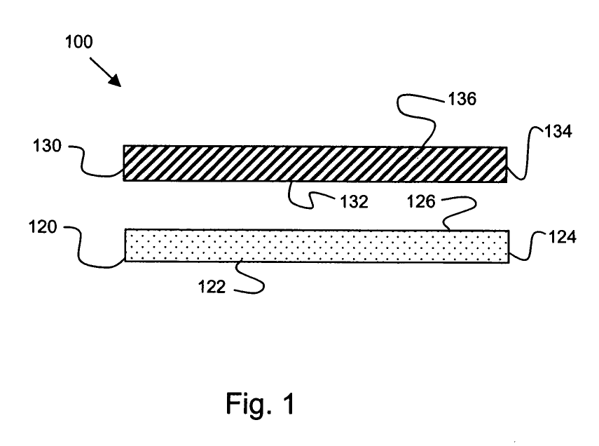

With reference to the first aspect, a secure label 100 comprising an embodiment according to the present invention is shown in FIG. 1. The label 100 may include an adhesive layer 120 and an obscuring layer 130. The adhesive layer 120 has a first surface 122, and a peripheral edge 124 that defines a boundary with a second surface 126. The label 100 may be adhered to a surface of a substrate (not shown). Confidential information may be supported on the substrate surface, and/or on one or more of the adhesive layer surfaces 122, 126. The obscuring layer 130 is described further hereinbelow.

With reference to an adhesive layer suitable for use with embodiments according to the present invention, the adhesive layer may be a continuous or a discontinuous layer. If a discontinuous layer, the adhesive layer may form a pattern, such as a ring, an array of spots, parallel lines, intersecting lines, etc.

The adhesive layer may include a structural adhesive, a mixture of a structural adhesive and a pressure sensitive adhesive, or both a structural adhesive and a pressure sensitive adhesive that are not admixed. A structural adhesive may be an adhesive that forms an interfacial bond having greater bond strength (adhesive strength) than the cohesive strength of either the substrate or the adhesive itself, or both. In one embodiment, the structural adhesive forms chemical bonds with, for example, polar groups located on a substrate surface. As such, the adhesive bond may be tenacious and can be selected to be resistant to aggressive agents or environments, such as solvents or acids in the case of agents, and temperature extremes in the case of environment. Other structural adhesives may be employed, alone or in combination with the above-described structural adhesives, that can strongly, but not permanently bond to a substrate surface. The bond strength can be determined by, for example, the selection of materials. In one embodiment, the structural adhesive cure mechanism cures the adhesive combination (structural adhesive+pressure sensitive adhesive) above the Dahlquist criterion and may be no longer tacky. In another embodiment, the structural adhesive may be a permanent and difficult to remove adhesive that is chemically bonded to a substrate surface. Upon removal of the label, the underlying substrate is destroyed. Other embodiments according to the invention include combinations, permutations and variations of the non-tacky/permanent type structural adhesives, as well as additional characteristics associated with structural adhesive, such as strong bonding capabilities at temperature extremes, surface tolerant bonding, hot/wet resistance and chemical resistances.

By way of contrast, a pressure sensitive adhesive comprises a contact adhesive that uses, for example, wetting principles and elasticity to form an adhesive bond with a substrate. Thus, in one embodiment, a pressure sensitive adhesive can allow for repositioning of an adhesive layer prior to adhesive placement for an extended period of time. The pressure sensitive adhesive generally firmly adheres to a variety of dissimilar surfaces upon mere contact without the need of more than light pressure, and remains tacky after cure or set to allow for repositionability. Some of the more tenacious pressure sensitive adhesives suitable for use make repositioning difficult to impossible, but by selecting a pressure sensitive adhesive with a predetermined tenacity or bond strength it may be possible to obtain an initially repositionable or an initially non-repositionable pressure sensitive adhesive characteristic, as desired. The combination of the structural adhesive and the pressure sensitive adhesive allows for fabrication using conventional pressure sensitive adhesive fabrication methods, and further allows for the subsequent increased bonding strength provided by a structural adhesive.

Suitable structural adhesives may include, for example, epoxies, acrylics such as acrylates and methacrylates, isocyanate-based polyurethanes, cyanate esters, derivatives or combinations thereof, and the like. The adhesives further may include self-priming or low temperature thermosetting-type structural adhesive compositions having a polar characteristic, a high surface energy and, when cured, a resistance to many types of environmental attack.

Suitable epoxy-based structural adhesives may be formed from resins having one or more functional oxiranyl (oxirane) groups. These epoxy-based structural adhesives may further have modifiers, such as hydroxyl-containing modifiers, that participate in a polymerization reaction.

Suitable acrylic-based structural adhesives include acrylate and methacrylate adhesives. In one embodiment, the adhesive may be formed from alkylene glycol diacrylate and/or methacrylate monomers. Such alkylene glycol diacrylate monomers can be selected from mono-, di-, tri- tetra- and polyethylene glycol dimethacrylate and corresponding diacrylates; dipentamethylene glycol dimethacrylate; tetraethylene glycol dichloroacrylate; diglycerol diacrylate; diglycerol tetramethacrylate; butylene glycol dimethacrylate; neopentyl glycol diacrylate; and trimethylopropane triacrylate. Additionally, suitable acrylic-based structural adhesives include ethoxylated trimethylolpropane triacrylate, trimethylol propane trimethacrylate, dipentaerythritol monohydroxy pentacrylate, pentaerythritol triacrylate, ethoxylated trimethylolpropane triacrylate, 1,6-hexanediol diacrylate, neopentyl glycol diacrylate, pentaerythritol tetraacrylate, 1,2-butylene glycol diacrylate, trimethylol propane ethoxylate trimethacrylate, glyceryl propoxylate trimethacrylate, trimethylol propane trimethacrylate, dipentaerythritol monohydroxy pentamethacrylate, tripropylene glycol dimethacrylate, neopentylglycol propoxylate dimethacrylate, 1,4-butanediol dimethacrylate, polyethylene glycol dimethacrylate, triethylene glycol dimethacrylate, butylene glycol dimethacrylate, ethoxylated bisphenol A dimethacrylate, combinations thereof, and the like.

Suitable polyurethane type monomers may be isocyanate based. In one embodiment, the adhesive may include urethane-acrylate-capped prepolymers based on polybutadiene polyols or polyamines and acrylates or methacrylates derived from bisphenol-A, such as bisphenol-A dimethacrylate, hydrogenated bisphenol-A dimethacrylate, and ethoxylated bisphenol-A dimethacrylate. Monofunctional acrylate esters (esters containing one acrylate group) also may be used. Also useful are the acrylate esters having a relatively polar moiety. Polar groups may be selected from labile hydrogen, heterocyclic ring, hydroxy, amino, cyano, and halogen polar groups. Examples of suitable compounds include cyclohexyl methacrylate, tetrahydrofurfuryl methacrylate, hydroxyethyl acrylate, hydroxypropyl methacrylate, t-butylaminoethyl methacrylate, cyanoethylacrylate, and chloroethyl methacrylate. The acrylate esters can be incorporated as reactive diluents capable of copolymerizing with various other polymerizable materials.

The structural adhesive can be based on epoxies, acrylics such as acrylates and methacrylates, isocyanate-based polyurethanes, cyanate esters, derivatives or combinations thereof, and the like. The pressure sensitive adhesive can be similarly based as well. In one embodiment, the pressure sensitive adhesive may be an epoxy cyclohexylmethyl epoxy cyclohexane carboxylate, or derivative or analog thereof. In another embodiment, the pressure sensitive adhesive may be a tri-functional acrylate monomer based on a glycerol derivative.

Pressure sensitive adhesives can be either permanent or removable/repositionable. In one embodiment according to the present invention, a permanent pressure sensitive adhesive may be used, and in an alternative embodiment, a removable pressure sensitive adhesive may be used. A pressure sensitive adhesive in accordance with the present invention may be an adhesive having a strong and tenacious initial tack when contacted to a surface, the contact requiring no more than low or minimal pressure to form the initial adhesive bond.

Suitable alternative pressure-sensitive adhesive materials include synthetic rubber-based and natural rubber-based adhesives, vinyl ether adhesives, silicone adhesives, and mixtures of two or more thereof. Also included are pressure sensitive adhesive materials described in Adhesion and Bonding, Encyclopedia of Polymer Science and Engineering, Vol. 1, pages 476-546, lnterscience Publishers, 2nd Ed. 1985, the disclosure of which is hereby incorporated by reference.

Some of the above-referenced suitable pressure sensitive adhesive materials may contain as a major constituent resin-based material such as acrylic type polymers, block copolymers, natural, reclaimed or styrene butadiene rubbers, tackified natural or synthetic rubbers, random copolymers of ethylene and vinyl acetate, ethylene-vinyl-acrylic terpolymers, polyisobutylene, poly(vinyl ether), and the like.

Suitable silicone-based pressure sensitive adhesives generally include two components, a polymer and a tackifying resin. The polymer can be a high molecular weight polydimethylsiloxane or polydimethyldiphenylsiloxane containing a terminal silanol group (SiOH), or a block copolymer that includes polydiorganosiloxane soft segments and urea terminated hard segments. The tackifying resin may be generally a silicate endcapped with trimethylsiloxy groups (OSiMe₃) and which contains a silanol group. Commercially available tackifying resins include SR 545 from General Electric Co., Silicone Resins Division (Waterford, N.Y.) and MQD-32-2 from Shin-Etsu Silicones of America, Inc. (Torrance, Calif.).

Additives may be present in the adhesive materials used to form the adhesive layer, and in other layers, such as intermediate layers, primer layers, print layers, and the like. For example, it may be possible to use UV curing to achieve a suitable tack for the pressure sensitive adhesive stage. If UV curing is desired, a UV initiator may be used. For example, a useful UV initiator includes a blend of monoacylphosphine oxide, oligo-(2-hydroxy-2-methyl-1-4 (1-methylvinyl)phenyl propanone, trimethyl benzophenone, and methylbenzophenone.

With further reference to additives, the adhesive layer can include a migratory and/or non-migratory additive. Suitable migratory additives include, for example, a flexibilizer, a plasticizer, an antioxidant, a blocking agent, and an anti-static agent. The flexibilizer can be, for example, a rubber, rubber-based derivative or thermoplastic. In this embodiment, the flexibilizer may be a rubber methacrylate. In an alternative embodiment, the flexibilizer may be carboxy terminated butadiene-nitrile rubber (CTBN).

The plasticizer can be a high-boiling temperature solvent or a softening agent, which in this instance may be liquid at room temperature. Specifically, the plasticizer may be an ester made from an anhydride or acid and a suitable alcohol having from about 6 carbon atoms to about 13 carbon atoms. Other suitable plasticizers include adipate, phosphate, benzoate or phthalate esters, polyalkylene oxides, sulfonamides, and the like. The plasticizers include dioctyl adipate plasticizer (DOA), triethylene glycol di-2-ethylhexanoate plasticizer (TEG-EH), trioctyl trimellitate plasticizer (TOTM), glyceryl triacetate plasticizer (TRIACETIN), 2,2,4-trimethyl-1,3-pentanediol diisobutyrate plasticizer (TXIB), diethyl phthalate plasticizer (DEP), dioctyl terephthalate plasticizer (DOTP), dimethyl phthalate plasticizer (DMP), dioctyl phthalate plasticizer (DOP), dibutyl phthalate plasticizer (DBP), polyethylene oxide, toluene sulfonamide, and dipropylene glycol benzoate.

The antioxidant provides radical trapping activity and may be generally selected with reference to at least some of the following considerations: the compatibility with the matrix of the adhesive layer, the effective stability of the antioxidant at the processing temperatures, whether the antioxidant will cause undesirable coloring, and whether the antioxidant will interact with other additives. Further, the antioxidant should inhibit ageing during processing, during storage and during the end use. Useful antioxidants include tert-butylhydroquinone, propyl gallate, sodium nitrate, sodium nitrite, butylated hydroxytoluene (BHT), and butylated hydroxyanisole (BHA) and analogs and derivatives. Suitable additives are commercially available from such suppliers as Ciba Specialty Chemicals, Inc. (Tarrytown, N.Y.) and Ferro Corp. (Independence, Ohio).

Suitable alternative or additional additives include atmosphere sensitive materials, solid and liquid tackifiers (also referred to as plasticizers), antioxidants, fillers, pigments, waxes, and commercially available equivalents. Atmosphere sensitive materials evidence exposure to atmosphere by irreversible changing a property, such as color, tack, flex, and the like. Useful additives are described in U.S. Pat. Nos. 5,192,612 and 5,346,766, both assigned to Avery International Corporation (Pasadena, Calif.), and which are incorporated herein by reference.

In one embodiment, the adhesive layer can be transparent to selected radiation (e.g., UV, IR or visible light) or can be selected to be opaque to particular preselected radiation types. By transparent, the adhesive layer may be permeable to electromagnetic radiation of specified frequencies, such as to visible light, and may be capable of transmitting light so that objects or images can be seen as if there were no or little intervening material. Thus, transparent film may include films that are colored or patterned, or semi-obscuring and the like. In one embodiment, a non-transparent film may be used.

In one embodiment, the adhesive layer may be formed from photo-polymerizable or UV curable monomers. Exposure to UV light polymerizes the monomers into a tacky pressure sensitive adhesive semisolid or viscoelastic mass. In one embodiment, the adhesive layer may be cured to have sufficient cohesive strength to stick to a release liner at a predetermined strength and not have insufficient integrity or be too liquid. In this or another embodiment, the adhesive layer may not be over-cured, which may inhibit the ability of the adhesive layer to flow properly, wet out a substrate surface, and adhere thereto. In yet another embodiment, the adhesive layer may be cured to a degree in a range wherein the adhesive layer has sufficient cohesive strength to be easily removed from a release liner, if one is used, and to provide enough structure or rigidity to reduce creep during processing (such as in a die-cut process), but not to a degree that the pressure sensitive adhesive characteristics are diminished.

Suitable UV curable monomers include ethylenically unsaturated compounds containing one or more olefinic double bonds, and are low molecular weight compounds (monomeric) or high molecular weight compounds (oligomeric). Illustrative examples of monomers containing one double bond are acrylates such as alkyl (meth) acrylates or hydroxyalkyl (meth) acrylates such as methyl-, ethyl-, butyl-, 2-ethylhexyl- or 2-hydroxyethylacrylate, iso-bornylacrylate, and methyl- or ethylmethacrylate. Further examples of photopolymerizable monomers are acrylonitrile, acrylamide, methacrylamide, N-substituted (meth) acrylamides, vinyl esters such as vinyl acetate, vinyl ethers such as isobutylvinyl ether, styrene, alkylstyrenes and halostyrenes, N-vinylpyrrolidone, vinyl chloride and vinylidene chloride. Exemplary UV curable monomers containing a double bond include diacrylates of ethylene glycol, 1,3-propylene glycol, 1,4-butaneodiol, 1,4-cyclohexane diol, neopentyl glycol, hexamethylene glycol, or bisphenol-A polyacrylates such as trimethylol propane triacrylate and pentaerythritol triacrylate or tetraacrylate, vinyl acrylate, divinyl benzene, divinyl succinate, diallyl phthalate, triallylphosphate, triallyl isocyanu rate and tris(2-acryloyloxy)ethyl-isocyanu rate.

Examples of high molecular weight (oligomeric) polyunsaturated compounds include acrylated epoxy resins, acrylated polyethers, acrylated polyurethanes or acrylated polyesters. Further examples of unsaturated oligomers include unsaturated polyester resins, which are normally prepared from maleic acid, phthalic acid, and one or more diols, and which have molecular weights in a range of from about 500 to about 3000. Such unsaturated oligomers can be referred to as prepolymers. Single component systems based on photocurable prepolymers can be used as a binder material.

Unsaturated compounds also can be used in admixture with non-photopolymerizable film-forming components. These components may typically be drying polymers or their solutions in organic solvents, such as nitrocellulose. They may be, however, chemically curable or thermocurable resins such as polyisocyanates, polyepoxides or melamine resins.

When UV curable monomers are selected for use in an adhesive layer, at least one photoinitiator should also be included. Many photoinitiators are commercially available for UV radiation curable systems. Suitable photoinitiators include those that undergo a unimolecular bond cleavage upon irradiation to yield free radicals, for example, benzophenone and benzophenone derivatives, benzoin ethers and esters, benzil ketals, dialkoxy acetophenones, hydroxyl acetophenones, amino acetophenones, halo acetophenones and amino alkyl, aceto and arylphosphine oxides. Other suitable types of photoinitiators include those that undergo a bimolecular reaction where the excited state of the photoinitiator interacts with a second molecule (i.e., a coinitiator) to generate free radicals, for example, amino benzophenones, amino thioxanthones, and titanocenes. Photoinitiators generally differ in that they have different absorption maxima. To cover a wide absorption range, it is possible to use a mixture of two or more photoinitiators. Useful amounts of photoinitiator in the UV radiation curable monomers are generally in a range of from about 0.05 weight percent to about 7 weight percent, or up to about 10 weight percent of the total composition. In this embodiment, the monomers contain an amount in a range of from about 0.2 weight percent to about 5 weight percent of the photoinitiator.

Amines and/or amino groups may be added to accelerate the photopolymerization. Useful amines include, for example, triethanolamine (TEA), N-methyl-diethanolamine (mDEA), p-dimethyl aminobenzoate and Michler's ketone. The photopolymerization can be accelerated further by the addition of a photosensitiser, which can displace or broaden spectral sensitivity. Useful photosensitizers include aromatic carbonyl compounds such as thioxanthone, anthraquinone and 3-acyl-coumarin derivatives as well as 3-(aroylmethylene)-thiazolines.

Hindered amine light stabilizers (HALS) which function as co-stabilizers, also may be added to the UV radiation curable printing compositions used in the present invention. Examples of hindered amine light stabilizers include those listed and recited in U.S. Pat. Nos. 5,112,890 and 4,636,408, which are incorporated herein by reference. A specific example of a hindered amine light stabilizer is bis(1,2,2,6,6-pentamethyl-4-piperidinyl) sebacate, which is commercially available as TINUVIN 292 from Ciba-Geigy Specialty Chemicals, Inc. (McIntosh, Ala.).

Suitable methods for applying the adhesive layer include a split-sheet laminator method. This is a drawdown method for coating sheets to provide low coat weight when using 100% solids systems. A bead of the adhesive may be placed on one sheet, and a second sheet may be placed in full planar contact with the first sheet to form a sandwich with the adhesive being disposed between the two sheets. The “sandwich” may be passed through a laminator at a pressure of, for example, 275 Kilopascals (40 P.S.I.). After the lamination, the sheets are split apart from each other, and the splitting forms a coating layer on the inner surfaces of the two sheets that are about the same in thickness as each other.

Another suitable method for applying the adhesive in accordance with the present invention is a lamination method. A layer of adhesive may be produced and disposed between two release sheets. The release sheets can be formed of, for example, a low surface energy material such as silicone. A first one of the liner release sheets may be removed. The adhesive may be contacted against the desired substrate while being supported by the remaining second one of the release liner sheets. When the second release liner sheet may be removed, all that remains is the adhesive layer supported by the desired substrate.

Other useful techniques for applying the adhesive layer to a substrate surface include gravure, reverse gravure, offset gravure, roller coating, brushing, knife-over roll, metering rod, reverse roll coating, doctor knife, dipping, die coating, spraying, curtain coating, slot head, flat screen and other similar methods. A useful metering rod is a Meyer Rod.

In one embodiment, the adhesive layer has a thickness in the range of from about 12.7 micrometers (0.5 mils) to about 127 micrometers (5 mils). In one embodiment, the thickness is in a range of from about 25.4 micrometers (1 mil) to about 76 micrometers (3 mils), and in another embodiment, the thickness is in a range of from about 25.4 micrometers (1 mil) to about 38 micrometers (1.5 mils). In one embodiment, the coat weight of the pressure sensitive adhesive in this embodiment is in a range of from about 10 grams per square meter (gsm) to about 20 gsm. In another embodiment according to the invention, the coat weight is in a range of about 21 gsm to about 50 gsm.

With further reference to FIG. 1, the obscuring layer 130 has a first major surface 132 that is in adhesive contact with the adhesive layer second surface 126. A peripheral edge 134 defines a boundary between the obscuring layer first surface 132 and an obscuring layer second surface 136. Both obscuring layer surfaces 132, 136 are generally planar, and are sized and shaped to sufficiently overlay, obscure and hide confidential information disposed on an underlying substrate surface during use.

Suitable obscuring layers may be of a scratch-off type or of a peel off type, or a combination thereof. The scratch-off type may be formed from a laminate or from a scratch-off coating composition.

As used herein, the term “scratch-off” means a material that can be removed, or partially removed, by scraping or scratching. The amount of pressure required to scrape off the scratch-off coating can be preselected with reference to a desired end use. In one embodiment, the scratch-off coating can be removed by scraping a finger nail or a coin edge along the scratch-off coating with finger pressure. In one embodiment, the scratch-off coating may be removed only by scraping the scratch-off coating with greater than finger pressure, or with an edge sharper than a coin or finger nail. Suitable solvent-based and water-based scratch-off coating compositions are commercially available from, for example, International Ink Company, Inc. (Gainesville, Ga.) or Craig Adhesives and Coatings, Inc. (Newark, N.J.).

Suitable methods for applying the scratch-off coating composition to an adhesive layer or to a film support include intaglio, silk screen, flexographic, gravure and gravure-type processes, letter press, offset printing, lamination methods and the like. An intaglio print may be one whose image is printed from a recessed design incised or etched into the surface of a plate. In this type of print, the ink lies below the surface of the plate and may be transferred to a surface under pressure. In one embodiment, the obscuring layer has a thickness in a range of from about 0.1 millimeter (mm) to about 1 mm, and in another embodiment the thickness is in a range of from about 1 mm to about 5 mm.

In one embodiment, the obscuring layer comprises a multi-layer film. The scratch-off coating composition can be pre-applied to a film to form a laminate or scratch-off assembly. The film of the laminate would then be adhered to the adhesive layer. The outward facing scratch-off coating layer would be removed from the film during a scratch-off process to reveal underlying confidential information. Alternatively, multiple scratch-off coatings can be layered over each other, each layer having differing properties, such as UV opacity, and visible light opacity. The obscuring layer can also support a logo, emblem, seal and the like.

In one embodiment, the obscuring layer comprises a peel-off layer. Peeling away or removing the obscuring layer precludes reattachment of the peel-off layer to the adhesive layer. That is, the adhesive layer may no longer be tacky and cannot rebond or restick to the obscuring layer. In addition, the obscuring layer may be configured so that the peeling force, or a scraping force for some scratch-off types, causes stretching and permanent colored stretch or strain marks to appear either in the obscuring layer or in the adhesive layer to indicate that the obscuring layer has been pulled away from the adhesive layer or scraped therefrom.

In one embodiment, the obscuring layer comprises a conventional polymer matrix, such as a linear low-density polyethylene, and one or more photoluminescent dyes. Mechanical deformation of the matrix causes a change in the fluorescence characteristic of the dyes, particularly in response to UV light. Suitable dyes include phase separable aggregates of, for example, commercially available cyano-oligo(p-phenylene vinylene). The aggregates can, for example, display excimer-type emissions, while the dye molecules after a breakup display monomer-type emission. Generally, an excimer is a di- or poly-atomic molecule existing in an energy level above the ground state. The mechanical deformation allows or causes the breakup of the aggregates into individual or isolated dye molecules, which may be dissolved in the polymer matrix. The change from excimer to monomer type emission results in a detectable shift or difference in response to UV light, for example, from red to green color.

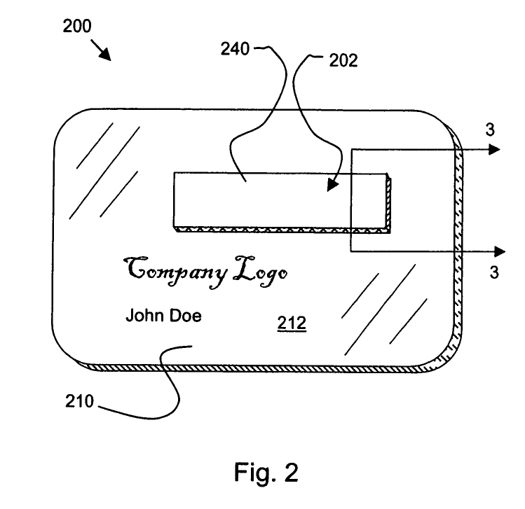

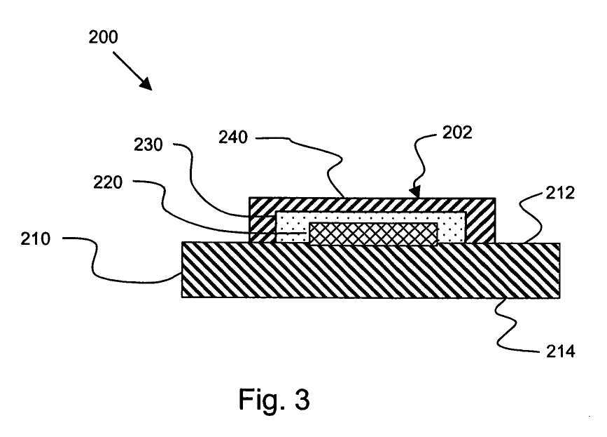

A secure article 200 comprising another embodiment of the present invention is shown in FIGS. 2-3. The article 200 includes a secure label 202, which is substantially similar to the secure label 100 shown in FIG. 1, but which is adhered to a substrate 210. With specific reference to FIG. 3, the substrate 210 has first and second major surfaces 212, 214. Confidential information 220, for example an activation code, may be supported on the substrate first major surface 212. An adhesive layer 230 overlays the confidential information 220, and an obscuring layer 240 overlays the adhesive layer 230 and may be bonded to the substrate first major surface 212 thereby.

The adhesive layer 230 may be substantially the same as the adhesive layer described above. In one embodiment, the adhesive layer 230 comprises a transparent, permanent structural adhesive. That is, the adhesive layer 230 may provide relatively high peel strength to the obscuring layer 240. In one embodiment, the adhesive layer 230 comprises a single adhesive material having a dual cure system. The dual cure system initially cures the single adhesive material to a tacky intermediate cure stage, like a pressure sensitive adhesive. In response to a predetermined act or event (such as the passage of a predetermined amount of time or the application of radiation), the adhesive material further cures to a final non-tacky cure stage of a structural adhesive. The activator or second portion of the dual cure system may be coated or disposed on the surface of the substrate surface and/or on a surface of the obscuring layer.

With reference to suitable substrates, in one embodiment, the substrate can be opaque. An opaque substrate can increase the tamper resistance of an article, for example, by blocking or reducing visible light transmission through a substrate to reveal data supported on the substrates opposing side. Accordingly, the substrate can be selected to be opaque to radiation such as, for example, visible light, ultraviolet (UV) light, infrared (IR) light, electron beam (EB) energy, and x-ray energy and to magnetic force. The opacity may be achieved by filler material present in the matrix of the substrate. Suitable fillers are commercially available and are interchangeable with each other to achieve a desired level and type of opacity. By selecting an opaque substrate, data supported on the substrate cannot be easily viewed or obtained, for example, by holding the article up to a strong light and viewing the supported data through the substrate. Alternatively, the substrate may be partly transparent, selectively transparent, or entirely transparent. For embodiments having a substrate with some transparency, an opaque laminate, such as a metal foil, can be permanently bonded to a substrate surface. In one embodiment, the substrate may be a solvent-based CRYSTAL FASCLEAR TC film facestock, which is commercially available from Avery Dennison Corporation (Pasadena, Calif.). In one embodiment, the substrate may be a biaxially oriented BOPP film, which is commercially available from, for example, UCB Films, Inc. (Smyrna, Ga.) or Avery Dennison Corporation (Pasadena, Calif.).

The substrate may be, in one embodiment, a die-cut plastic card formed from a flexible, monolayer polyethylene film. In one embodiment, the substrate has an edge with a length and width that are about 5 centimeters (cm) by about 8.5 cm, and a thickness that may be about 0.25 cm, making it about wallet-sized. In one embodiment, the substrate may be about 51 micrometers (2.0 mil) thick.

The substrate may be extruded or may be otherwise formed, and can be a monolayer or multi-layered film or composite. A suitable substrate can be formed of materials such as non-ethylenic olefin polymers (linear or branched) or polyolefins, polyamides, polystyrenes, nylon, polyesters, polyester copolymers, polyurethanes, polyacrylates, polysulfones, styrene-maleic anhydride copolymers, styrene-acrylonitrile copolymers, ionomers based on sodium or zinc salts of ethylene methacrylic acid, polymethyl methacrylates, cellulosics (including both paper and wood products), fluoroplastics, polycarbonates, polyacrylonitriles, polycyanurates, ethylene-vinyl acetate copolymers, metals, ceramics, and combinations thereof. The polyacrylates include acrylates such as those derived from ethylene methacrylic acid, ethylene methyl acrylate, ethylene acrylic acid and ethylene ethyl acrylate. In one embodiment, the substrate may be selected from polycarbonate, glass, stainless steel (SS), polyvinyl Chloride (PVC), and polypropylene (PP).

With reference to confidential or secured information that may be hidden by an obscuring layer, the confidential information can be formed by printing using an ink composition. When applied, the ink composition can contain greater than 50% solids, in another embodiment greater than 75%, and in yet another embodiment greater than 85% solids. In one embodiment, the ink composition may be 100% solids and may comprise an ultraviolet radiation (UV) curable ink. Useful UV curable inks generally include one or more photopolymerizable monomeric binder materials and should contain at least one photoinitiator. Useful binder materials and photoinitiators are substantially the same as the UV curable monomers and photoinitiators disclosed hereinabove.

In addition to the above described binder materials and photoinitiators, the UV curable inks suitable for use with this embodiment can contain at least one colorant selected from inorganic pigments; body pigments; opacifiers; holographic, magnetic, magnetizable, metallic or retroreflective flakes, fibers or whiskers; dyes; prismatic, retro-reflective or radiation-absorbent crystals; and reflective, fluorescent, pearlescent, organic pigments, such as proteins or peptides, and the like, all of which are commercially available. Examples of useful pigments include titanium dioxide, cadmium yellow, cadmium red, cadmium maroon, black iron oxide, chrome green, and powders and flakes of such metals as gold, silver, aluminum and copper, and oxides and alloys thereof. Examples of dyes include alizarine red, Prussion blue, auramin naphthol, malachite green, and commercially interchangeable alternatives. Useful concentrations of the colorant are in a range of from about 0.01 weight percent to about 100 weight percent based on the composition total weight. In one embodiment, the concentration of the colorant may be in a range of from about one weight percent to about 50 weight percent, and in another embodiment the colorant may be in a range of from about 51 weight percent to about 99 weight percent.

The ink composition may also contain at least one UV absorber that provides weathering protection and helps prevent micro-cracking of the color image. If present, the amount of UV absorber included in the UV radiation curable ink should be maintained at a practical minimum since the presence of the UV absorber may sometimes increase the curing rate to an undesirable level. A variety of UV absorbers useful in the present invention are commercially available. These UV absorbers include those belonging to the group of photopolymerizable hydroxyl benzophenones and photopolymerizable benzotriazoles. U.S. Pat. No. 5,369,140 which is hereby incorporated by reference, describes a class of 2-hydroxyphenyl-s-triazines that are useful as UV absorbers for radiation curable systems, the disclosure of which is hereby incorporated by reference. Triazines are effective for extending the stabilization of cured films that are exposed to sunlight, and these stabilizers do not generally interfere with UV radiation curing of the inks. The triazine UV absorbers are effective in amounts of from about 0.1 weight percent to about 2 weight percent based on the composition total weight. The UV absorbers may be used in combination with other light stabilizers, such as sterically hindered amines. U.S. Pat. Nos. 5,559,163 and 5,162,390, which are hereby incorporated by reference, describe other useful UV absorbers. In alternative embodiments in which the confidential information is intended to be UV transparent, such UV absorbers generally are not present.

The ink composition can be selected with reference to the ink cure mechanism to be transparent to a particular radiation or spectrum of radiation. That is, the ink composition can be formulated from materials causing the confidential information to be detectable by a select light frequency, while radiation of other frequencies passes through the ink composition. The selection of materials for the fabrication of the obscuring layer can be made with reference to the ink composition selection. That is, the obscuring layer can be formed of materials that can block the detectable light frequency of the confidential information. For example, if an ink composition may be selected so that it may be visible to light in the visible light spectrum but may be transparent to light in the UV spectrum, then the obscuring layer can be selected to be opaque to light in the visible spectrum and can be either transparent or opaque to light in the UV spectrum. Detection of the confidential information using UV light would not be likely in the foregoing example as any light that could detect the confidential information (i.e., visible spectrum) would be blocked, and light unable to detect the confidential information (i.e., UV) could pass through both the obscuring layer, or be blocked thereby. In a similar manner, materials can be selected that are obscuring or transparent to magnetic force. Substrates may also be selected to be opaque or transparent in a similar manner.

During fabrication or manufacture, the information to be secured may be printed onto a portion of the substrate surface. That portion of the substrate surface may be treated with an initiator and may be overlayed with an adhesive layer of a predetermined thickness. The adhesive layer may be irradiated with UV light to cure the adhesive layer to an intermediate state having a desirable level of tackiness. Other less confidential information can be printed onto the substrate surface spaced from the information, such as a company logo, a control or lot number, or a personal identifier, for example, the consumer's name.

The obscuring layer may be treated with an initiator and then may be adhered to the adhesive layer by the pressure sensitive adhesive characteristics of the adhesive layer in the intermediate cure stage. The adhesive layer may be thus contacted on both surfaces by the initiator. The initiator can be latent or may be repressed until disposed into an anaerobic environment.

The substrate and the obscuring layer may cooperate to create an anaerobic environment. In response to the formation of the anaerobic environment and the presence of the initiator, the adhesive layer advances from an intermediate cure stage to a final cure stage during a predetermined cure time length. The final cure time length may be determined by the formulation of adhesive in the adhesive layer, the selection and amount of metal containing initiator used, and cure conditions (temperature, humidity, and the like). Achieving a final cure stage results in the pressure sensitive adhesive characteristics being replaced by structural adhesive characteristics.

During use, a secure label according to the present invention may reduce or eliminate unevidenced access to the information. A peel-off obscuring layer may be pulled away from an adhesive layer and removed. The removal of the obscuring layer may be indicated by the stretch marks in the body of the obscuring layer. Additionally, it may be impossible to reattach the obscuring layer to a substrate using the adhesive layer as the adhesive layer is no longer tacky. The information may be visible through the transparent adhesive layer and can be obtained by the consumer for use.

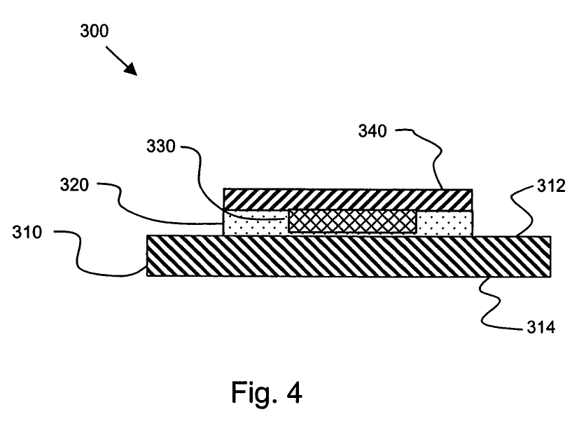

An adhesive article 300 comprising another embodiment of the present invention is shown in FIG. 4. FIG. 4 is a partial, cross-sectional view similar to the view shown in FIG. 3. The adhesive article 300 includes a substrate 310 having first and second major surfaces 312, 314, and may be, for example, a lottery ticket. An adhesive layer 320 overlays a portion of the substrate first major surface 312. Confidential data 330 that may be, for example, a win/lose indicia is embedded in the adhesive layer 320 and is bonded to the substrate first major surface 312 thereby. Obscuring layer 340 overlays the adhesive layer 320 and the data 330, and may be bonded to the substrate first major surface 312, but not to the data 330. The data 330 may be top coated with a release agent or film to reduce or eliminate bonding to the obscuring layer 340.

The substrate may be similar to the substrates describe above. In one embodiment, the substrate comprises a paper or cellulosic, plastic, or metal sheet. The confidential information or data may be in the form of a paper insert, or can be made of metal or plastic. Alternatively, the confidential information can be formed from a polymeric or ink composition that is printed onto or embossed into the adhesive layer. In one embodiment, the outer surface of the confidential information may be about flush with the outer surface of the adhesive layer. The adhesive layer may be the same or similar to the adhesive layers described above.

The obscuring layer may be formed from a scratch-off coating or a peel off layer that is substantially similar to those described above. The obscuring layer blocks the view of the confidential information until removed from the adhesive layer. The act of scratching-off or peeling the obscuring layer destroys the obscuring layer and precludes its replacement over the adhesive layer.

During use, the obscuring layer may be removed by scratching off or peeling at least an obscuring portion of the obscuring layer. The confidential information may be revealed thereby. Because the obscuring layer cannot be replaced over the confidential information, having been consumed or destroyed in the scratching off or peeling process, the status of the article as being used may be clearly obvious by a casual observation.

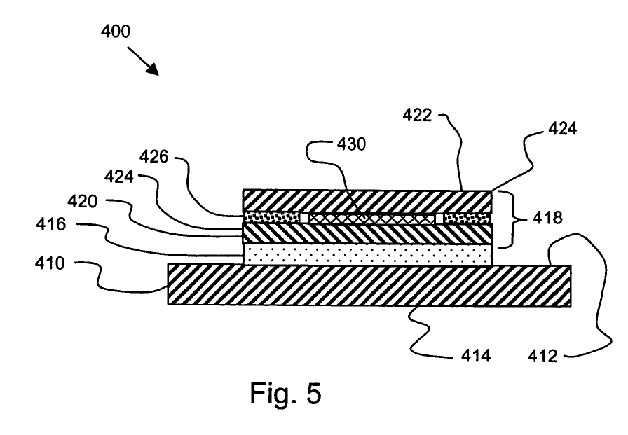

An adhesive article 400 comprising yet another embodiment according to the present invention is shown in FIG. 5. The adhesive article 400 includes a substrate 410 that is substantially similar to the substrates described above. The substrate 410 includes first and second major surfaces 412, 414. An adhesive layer 416 overlays a portion of the substrate first major surface 412. An envelope structure 418 may be bonded to the substrate first major surface 412 by the adhesive layer 416. The envelope structure 418 includes first and second obscuring layers 420, 422. The first and second obscuring layers 420, 422 each have a peripheral edge 424, are sealed to each other at a seam 426 at their peripheral edge 424. The seam 426 can be formed by, for example, a heat sealing process or the like. By sealing the first and second obscuring layers 420, 422 to each other at their peripheral edge 424, a cavity may be formed.

A plate or card 430 or the like may be disposed in the cavity between the first and second obscuring layers 420, 422. The card 430 contains confidential information in the form of, for example, a device such as a computer chip, a radio frequency identification (RFID) chip, a magnetic strip or other data storage medium, or a printed indicia (letters; numbers; alphanumeric code; two, three or multidimensional bar code; laser-etched item; and the like). Generally, if a device such as an RFID is disposed in the envelope 418, the first and second obscuring layers 420, 422 are opaque to radio frequencies that would substantively interact with the device. The same for other items or devices disposed within the cavity. Optionally, the card 430 can be attached to either of the obscuring layers 420, 422. The first and second obscuring layers 420, 422 can be peeled apart from each other or cracked open along a second seam or crack line (not shown) to access the interior of the cavity and the confidential information located therein. A pull tab (not shown) can be used to facilitate the peel process. The adhesive layer is substantially similar to the adhesive layers described above.

During fabrication of one embodiment, the first and second obscuring layers 420, 422 are sealed together with the card 430 inside the cavity formed. The adhering side of one of the obscuring layers 420, 422 and the substrate first major surface 412 are treated with an initiator. The adhesive layer 416 is applied to substrate first major surface 412, and the envelope 418 may be adhered to the tacky outer surface of the adhesive layer 416. After a predetermined length of time, the adhesive layer 416 switches from tacky and repositionable to non-tacky and permanent. The adhesive layer 416 may be preselected to have a peel strength greater than the cohesive tear strength of at least the second obscuring layer 422.

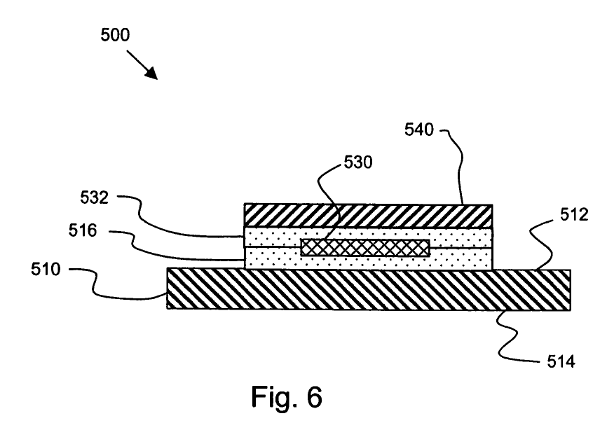

A secure article 500 comprising another embodiment of the present invention is shown in FIG. 6, which is a view taken along a line similar to that shown in FIG. 3.

The secure article 500 includes a substrate 510 similar to the substrates described above. The substrate 500 has first and second major surfaces 512, 514.

A first layer of adhesive 516 overlays a portion of the substrate first major surface 512. The first layer of adhesive 516 is similar to the adhesive layers described above. Confidential information 530, such as in the form of printed material, may be supported on the adhesive first layer 516. A transparent second layer of adhesive 532 overlays the adhesive first layer 516 and the confidential information 530. The adhesive second layer 532 is similar to the adhesive layer 230 shown in FIGS. 2-3. An obscuring layer 540 overlays the adhesive second layer 532 and obscures the view of the confidential information 530.

During use, the obscuring layer 540 remains bonded to the adhesive second layer 532 until removal by the intended consumer. The obscuring layer 540 may be peeled back or scratched-off from the adhesive second layer 532. The confidential information 530 may be then visible or readable through the transparent adhesive second layer 532. The obscuring layer 540 may be destroyed and otherwise not re-attachable to the adhesive second layer 532.

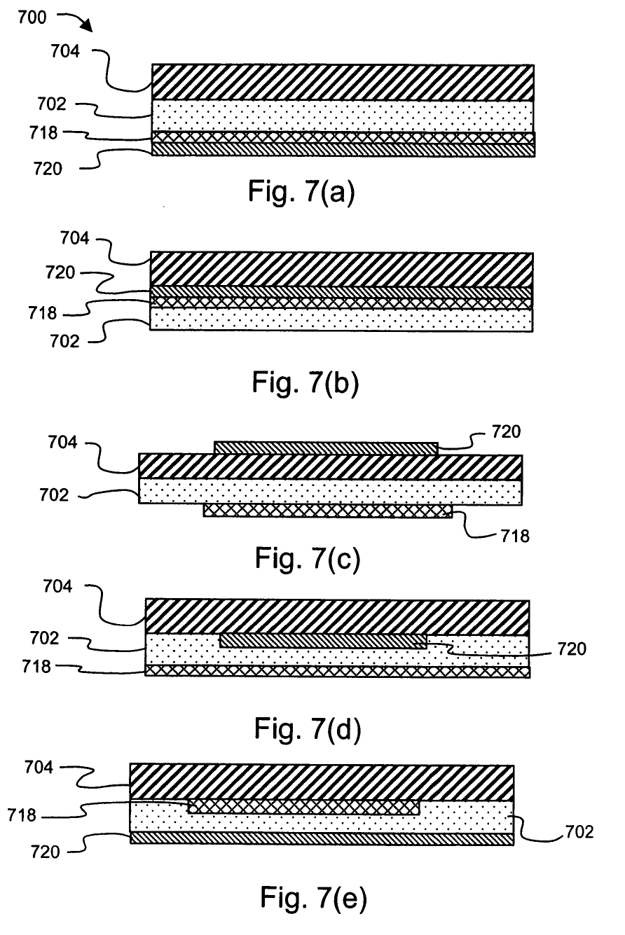

Embodiments and configurations of secure label components according to the present invention are shown in FIGS. 7(a)-7(c). FIGS. 7(a)-7(c) each show an adhesive layer 702 and an obscuring layer 704. FIG. 7(c) also shows an optional release liner 716 releasably adhered to adhesive layer 702. Corresponding parts in FIGS. 7(a)-7(c) have the same reference numerals, and, where appropriate, are differentiated by a parenthetical letter to signify a particular drawing figure. The adhesive layer 702 has a first surface 706, and a second, opposing surface 708. The adhesive layer 702 is substantially similar to the adhesive layers described above. The obscuring layer 704 has a first surface 710, and a second, opposing surface 712. The obscuring layer 704 is substantially similar to the obscuring layers described above. The obscuring layer 704 may be in planar contact with the adhesive layer 702 and may be adhered thereto either directly or indirectly. If directly adhered thereto, then there are no intervening layers, such as a tie layer, intermediate layer or a skin layer. If indirectly adhered thereto, then there can be, for example, one or more tie layer, intermediate layer, skin layer, or other layer or combinations of two or more thereof as intervening layer(s). The release liner 716 may be a commercially available release sheet or film, such as the FASSON 35#MF Release Liner or the ULTRALINER, which are commercially available from Avery Dennison Corporation (Pasadena, Calif.).

The confidential information protected by the obscuring layer may be used in combination with one or more print layers within the label construction. Such print layers may be visible, or may be hidden by the obscuring layer. FIGS. 7(a) to 7(e) illustrate several embodiments of the label of the present invention comprising an obscuring layer 704, an adhesive layer 702, a print layer 720, and a confidential information layer 718.

FIG. 7(a) shows a secure article 700 having obscuring layer 704 adhered to adhesive layer 702. Adhesive layer 702 overlies confidential information layer 718, which overlies print layer 720. Print layer 720 can be printed directly onto an underlying substrate. The print layer may include, for example, directions for use, contact information, trademarks, graphic designs or any other non-confidential information.

FIG. 7(b) shows a secure article 700 wherein the print layer 720 and the confidential information layer 718 are positioned between the obscuring layer 704 and the adhesive layer 702. the print layer 720 does not obscure the confidential information layer 718 so that upon removal of the obscuring layer 704, the confidential information layer 718 is accessible.

FIG. 7(c) shows an embodiment wherein the print layer 720 overlies the obscuring layer 704 and the adhesive layer 702 overlies the confidential information layer 718.

FIG. 7(d) illustrates a secure label wherein the print layer 720 is positioned between the obscuring layer 704 and the adhesive layer 702. Adhesive layer 702 overlies confidential information layer 718.

FIG. 7(e) shows one embodiment of the secure label having confidential information layer 718 positioned between the obscuring layer 704 and adhesive layer 702. Adhesive layer 702 overlies print layer 720.

In alternative embodiments (not shown), additional functional layers may be interspersed between the confidential information layers, the print layers, the adhesive layer, and the obscuring layer. The functional layers can be coextensive with one or more of the adjacent other layers (e.g., the obscuring layer) or can overlay only a portion of one of the surfaces of the adjacent other layer.

These functional layers can include, for example, tie layers, intermediate layers, and/or primer layers. And, the functional layers can have multiple functions, for example, an intermediate layer between the print layer and the obscuring layer can include an opacifying agent and a blocking agent. In such an embodiment, the confidential information layer may be disposed between the print layer and the obscuring layer so that the confidential information would be visible once the obscuring layer was removed (e.g., the scratch-off coating was removed therefrom). Because the confidential information layers can be selectively transparent to radiation frequencies, the opacity of a functional layer can differ from the detecting radiation frequency. Thus, a visibly opaque functional layer can be utilized (transparent to UV light) and an ultraviolet-detectable ink can be used for one or more of the confidential information layers.

In a similar manner, a primer layer may be utilized between any of the surfaces supporting one of the print layers. The primer layer aids in accepting print and/or ink, or imparts a desired property to or enhances a desired property of a surface. The additional functional layers can be affixed to the desired surface by commercial available techniques, or can be co-formed during manufacture, such as by co-extrusion.

During manufacture, one or more of each of the confidential information layers or of the print layers may be applied to one of the supporting surfaces. The confidential information layers and the print layers may be held in place, affixed, or adhered by the pressure sensitive adhesive properties of the adhesive layer, functional layers as appropriate, or by other fastening means. Other fastening means includes, for example, utilizing self adhesive properties inherent in preselected types of the confidential information layers and the print, that is, self-adhesive inks and the like; radiation treating, pressure or friction welding, or solvent melt processes; mechanical fastening to include physical embedding, riveting and snap-fitting; and the like; and combinations thereof.

While a minimum of one of the secured information layers may be necessary for one embodiment, the assembly intermediate or label in accordance with one embodiment of the present invention can be prepared for the addition of the secured information at a future time. For example, the obscuring layer and the adhesive layer can be prepared alone or with an additional layer, for example, the release liner, or a temporary transport or carrier film to form the assembly intermediate or label. The secured information can be preprinted on cards or the like at a remote location. The assembly intermediate or label can then be made commercially available to the assembler of the cards, who can cut the label intermediate to a desired shape and size, strip the release liner or transport layer, if one is present, and apply the assembly intermediate or label to the cards over the secured information.

In one embodiment, the print layer can be printed (in reverse) to the outward facing surface of the release liner. The release liner may be assembled with the adhesive layer and the obscuring layer, and any other layers to be included (e.g., a facestock layer, skin layer, tie layer, and the like) to form a secure label. The secure label may be then wound into a roll. The print layer may be transferred by the rolling from the outward face of the release liner to the obscuring layer second surface. When unwound, the print layer remains on the obscuring layer second surface and releases from the outward facing surface of the release liner.

In an alternative embodiment, one or more of the print layers may be printed to a transfer layer or the like, and subsequently transferred to one or more of the surfaces capable of supporting one of the print layers. Further, the adhesive layer can be formed on a temporary transport or carrier layer, and one of the two print layers supported by the adhesive layer can be printed, embedded, and/or laminated to a respective one of the adhesive layer surfaces.

The secure label may also be manufactured in sheet form, that is, unwound form. A sheet form secure label may be particularly suited for embodiments wherein one or more of the component layers may be inflexible, brittle, stiff, thick, spongy, or otherwise less suited for rolling or rolled applications.

A secure system 800 for indicating the authenticity of an item comprising embodiments according to the second aspect of the present invention is shown in FIG. 8. The secure system 800 may include a substrate 810 having an upper surface 812, and an authenticating layer 820 on the upper surface 812. The authenticating layer 820 includes an outer layer 822 and an inner adhesive layer 824. The outer layer 822 has an outer surface 826 and in one embodiment may be a metallic film. In another embodiment, the outer layer is embossable. As used herein the term “embossable” means that the outer layer comprises a film responsive to heat and/or pressure by deforming in a predetermined pattern. The embossable film may comprise a thermoplastic film. In another embodiment, the outer layer comprises a film that is laser etchable or laser ablatable.

The outer layer 822 is shown partially cut-away to reveal an outer surface 828 of the adhesive layer 824. An inner surface of the outer layer 822 may be adhesively affixed to the adhesive layer outer surface 828. The adhesive layer 824 may be substantially the same as the adhesive layers described above. The outer layer 822 can be imprinted with a certifying seal or stamp to indicate authenticity. The authenticating layer 820 may be adhesively affixed to an article of commerce to signify that the article is authentic and genuine.

In one embodiment, the authenticating layer has a certifying image, code or the like, for example, a difficult to copy holographic image. The certifying image may be integral with, or functionally inseparable from, the outer layer, and either may be in addition to or in place of an embossment or raised seal. The embossment can be formed in the outer layer prior to, subsequent to, or during adhesive placement of the authenticating layer onto an item. In one embodiment, the embossment may be formed by pressure from a stamp or stamp-like device. In another embodiment, the outer layer may be formed from thermoplastic resin and the embossment may be formed by heat and a relatively small amount of pressure from a heat-sealing-type device. In yet another embodiment, an embossment may be created by abrasion or ablation in a predetermined pattern by, for example, a laser generating device. In addition, the outer layer may include a commercially available thermochromic ink composition so that an irreversible, temperature-induced color change, or lack thereof, may be included to further increase the difficulty in copying or otherwise tampering with the authenticating layer.

A secure label 850 may be disposed on the upper surface 812 of the substrate 810. The secure label 850 includes a transparent outer film 852 and a transparent adhesive layer 854. The film 852 has an outer surface 854 that can be printed thereon, or may be a multi-layered film that may include a skin layer or print layer, which can have print or ink disposed thereon, for example, the thermochromic ink composition disclosed above.

The label adhesive layer 854 may be substantially the same as the adhesive layers described above, with the proviso that it is transparent to at least one of visible light or to another preselected radiation. Information can be printed or written onto the substrate. For example, the information can be a signature, a machine readable certificate, or an encryption key. The adhesive layer may also contain filler material that allows viewing therethrough, but inhibits or prevents photocopying. In one embodiment, the filler comprises glass spheres. In one embodiment, a secure label includes holographic image that does not unduly interfere with the viewing of the information through the secure label but may be difficult or impossible to reproduce or to forge.

During application, the information may be disposed onto the substrate upper surface, such as by signing a bank draft with a ball point pen to form an original signature. The secure label may be adhered to the substrate upper surface over at least a portion of the information. When the secure label is positioned over the information and is adhered to the substrate upper surface, it precludes tampering with the information located therebeneath. That is, the label adhesive layer forms a permanent bond with the substrate upper surface, or rather, a structural adhesive component of the label adhesive layer forms the permanent bond. Practical examples of suitable uses for the secure label include placement over a value amount, a signature, a counter-signature, and/or an authentication on a bank cheque, money order or bearer bond. In one embodiment, the secure label connects to the substrate via a pressure sensitive adhesive, and adhesively affixes thereto via a structural adhesive component, so that the information cannot be altered without destroying the secure label or the substrate. The underlying information can be viewed through the transparent secure label.

### EXAMPLES

Following are examples of adhesive formulations that may be used to form the adhesive layer.

### Example 1

Table 1 lists a formulation that uses an intermediate cure step to produce pressure sensitive adhesive characteristics.

TABLE 1

| | Approximate Amount |
|---|---|
| Description of Ingredients | (percent of total weight) |
| LOCTITE SPEEDBONDER 326 | 57 |
| BR 3042 | 30 |
| UCB EBECRYL P115 | 10 |
| SARCURE SR 1135 | 3 |

SPEEDBONDER 326, an anaerobic structural adhesive containing a urethane methacrylate from Loctite; BR 3042, an aromatic difunctional polyether urethane acrylate available from Bomar Specialties Company; EBECRYL P115, a reactive amine available from UCB Chemicals Group and SARCURE SR1135, a photoinitiator containing a blend of phosphine oxide, trimethyl benzophenone and methylbenzophenone and oligo phenyl propanones available from Sartomer Company are mixed together in the amounts listed above.

The adhesive composition is applied to a prepared polyethylene terepthalate (PET) surface using a # 22 Meyer Rod (22 micrometers or microns). Ultraviolet (UV) lamp curing systems are used to cure the composition to an adhesive having pressure sensitive adhesive properties. Suitable UV lamp systems include FUSION H600 and D600 bulbs, which are both commercially available from Fusion UV Systems, Inc. (Torrance, Calif.). The lamp systems are operated at full power: about 240 watts/cm (600 watts/inch) and at a belt speed of about 75 feet per minute (FPM) for four passes. The resulting adhesive bonds to the surface of the PET substrate, is tacky and has pressure sensitive adhesive characteristics.

LOCTITE 7649 PRIMER, an acetone based copper salt activator, is sprayed onto a surface of a prepared stainless steel substrate. The PET film coated with the adhesive is applied to the surface of the prepared stainless steel and allowed to cure for 30 minutes. The adhesive maintains the PET substrate in adhesive contact with the stainless steel substrate for at least 30 minutes. This is due to the pressure sensitive adhesive characteristics of the adhesive. During the 30-minute contact period, the adhesive material cures from an intermediate stage to a final stage. The final stage is the non-tacky structural, permanent adhesive. That is, after the 30 minutes, the adhesive has lost the tackiness associated with a pressure sensitive adhesive, and has formed the structural adhesive properties in place of the pressure sensitive adhesive characteristics.

### Example 1(a)

The adhesive coating of Example 1 on a PET film is applied to an untreated stainless steel substrate, e.g., a stainless steel substrate without an accelerator applied thereto. The adhesive coating is allowed to cure for a period of 24 hours. After 24 hours, the cured adhesive has formed the structural adhesive properties in place of the pressure sensitive adhesive characteristics.

### Example 2

An adhesive is prepared substantially in accordance with the procedure of Example 1, with the following ingredients:

TABLE 2

| | Approximate Amount |
|---|---|
| Description of Ingredients | (percent of total weight) |
| LOCTITE SPEEDBONDER 326 | 70 |
| BR 3042 | 20 |
| UCB EBECRYL P115 | 5 |
| SARCURE SR 1135 | 5 |

The resulting adhesive exhibits initial pressure sensitive adhesive properties when applied to a substrate that has been pretreated with a transition metal accelerator (Product 7649 from Loctite). The peel strength of the adhesive increases when the adhesive is allowed to cure for a 2 hour period of time.

### Example 3

The adhesive of Example 3 is prepared substantially in accordance with the procedure of Example 1, with the exception that the following ingredients are used:

TABLE 3

| | Approximate Amount |
|---|---|
| Description of Ingredients | (percent of total weight) |
| LOCTITE SPEEDBONDER 326 | 50 |
| SARTOMER 0N3004 | 40 |
| UCB EBECRYL 7100 | 5 |
| SARCURE SR 1135 | 5 |

CN3004 is a blend of acrylic monomer and a hydrocarbon tackifier resin available from Sartomer Company. Ebecryl 7100 is an amine functional acrylate available from UCB Chemicals Group. The resulting adhesive exhibits initial pressure sensitive adhesive properties when applied to a substrate that has been pretreated with a transition metal accelerator (Product 7649 from Loctite). The adhesive exhibits structural adhesive properties subsequent to an additional curing period.

### Example 4

An adhesive is prepared substantially in accordance with the procedure of Example 1, with the following ingredients:

TABLE 4

| | Approximate Amount |
|---|---|
| Description of Ingredients | (percent of total weight) |
| BOMAR BR-3042 | 10 |
| SARTOMER CN 3002 | 60 |
| UCB EBECRYL 7100 | 5 |
| SARTOMER SR 1135 (SARCURE) | 5 |
| LOCTITE SPEEDBONDER 326 | 20 |

CN3002 is a blend of acrylic monomer and hydrocarbon tackifier resin available from Sartomer Company. The resulting adhesive exhibits initial pressure sensitive adhesive properties when applied to a substrate that has been pretreated with a transition metal accelerator (Product 7649 from Loctite). The peel strength of the adhesive increases when the adhesive is allowed to cure for a 48 hour period of time.

The processes and embodiments described herein are examples of structures, systems and methods having elements corresponding to the elements of the invention recited in the claims. This written description may enable those skilled in the art to make and use embodiments having alternative elements that likewise correspond to the elements of the invention recited in the claims. The intended scope of the invention thus includes other structures, systems and methods that do not differ from the literal language of the claims, and further includes other structures, systems and methods with insubstantial differences from the literal language of the claims.

1. A security label comprising:
a protecting layer having an upper surface and a lower surface; and
an adhesive layer having an upper surface and a lower surface, wherein the upper surface is adhered to the lower surface of the protecting layer and wherein upon application of the label to a substrate, the adhesive layer initially adheres to the substrate in response to light pressure and subsequently adheres to the substrate with a bond strength equal to or greater than the cohesive strength of the substrate or adhesive layer.

2. The security label of claim 1 wherein the adhesive comprises an anaerobically curable polymer or monomer.

3. The security label of claim 2 wherein the adhesive comprises an acrylate or methacrylate.

4. The security label of claim 2 wherein the adhesive further comprises a tackifier.

5. The security label of claim 1 wherein the adhesive comprises a structural adhesive component and a pressure sensitive adhesive component.

6. The security label of claim 1 wherein the protecting layer comprises a transparent film.

7. The security label of claim 6 wherein the adhesive layer comprises a transparent adhesive.

8. The security label of claim 1 wherein the protecting layer comprises a holographic image.

9. The security label of claim 1 wherein the protecting layer comprises a metallic film.

10. The security label of claim 1 wherein the protecting layer comprises a thermoplastic film responsive to heat or pressure by deforming in a predetermined pattern.

11. The security label of claim 1 wherein the protecting layer is laser etchable.

12. The security label of claim 1 wherein the protecting layer comprises an obscuring layer.

13. The security label of claim 12 wherein the obscuring layer comprises a scratch-off layer.

14. The security label of claim 12 wherein the obscuring layer comprises a peel-off layer.

15. The security label of claim 1 further comprising a release liner releasably adhered to the lower surface of the adhesive layer.

16. The security label of claim 1 further comprising a print layer.

17. The security label of claim 1 wherein the protecting layer comprises a multilayer film.

18. The security label of claim 1 further comprising a thermochromic ink supported by the protecting layer or the adhesive layer.

19. The security label of claim 12 wherein the obscuring layer comprises a first sublayer and a second sublayer secured to each other along a peripheral edge to form a cavity, wherein secured information is disposed within the cavity.

20. The security label of claim 19 wherein the first sublayer is the outermost layer and comprises a scratch-off coating.

21. The security label of claim 19 wherein the first sublayer is the outermost layer and comprises a peel-off film.

22. The secure label of claim 12 wherein the obscuring layer is opaque to radiation selected from visible, infrared, ultraviolet, x-ray, and electron beam.

23. The security label of claim 1 further comprising a secured information layer underlying the protecting layer.

24. A secured article comprising:
a label comprising a protecting layer having an upper surface and a lower surface; and an adhesive layer having an upper surface and a lower surface, wherein the upper surface of the adhesive layer is adhered to the lower surface of the protecting layer;
a secured information layer underlying the protecting layer;
a substrate having an upper surface; and
wherein upon application of the label to the substrate, the adhesive layer initially adheres to the substrate in response to light pressure and subsequently adheres to the substrate with a bond strength equal to or greater than the cohesive strength of the substrate or adhesive layer.

25. The secured article of claim 24 wherein the adhesive comprises an anaerobically curable polymer or monomer.

26. The secured article of claim 25 wherein the adhesive comprises an acrylate or methacrylate.

27. The secured article of claim 24 wherein the adhesive further comprises a tackifier.

28. The secured article of claim 24 wherein the adhesive comprises a structural adhesive component and a pressure sensitive adhesive component.

29. The secured article of claim 24 wherein the protecting layer comprises a transparent film.

30. The secured article of claim 29 wherein the adhesive layer comprises a transparent adhesive.

31. The secured article of claim 30 wherein the protecting layer comprises a holographic image.

32. The secured article of claim 24 wherein the protecting layer comprises a metallic film.

33. The secured article of claim 24 wherein the protecting layer comprises a thermoplastic film responsive to heat and pressure by deforming in a predetermined pattern.

34. The secured article of claim 24 wherein the protecting layer is laser etchable.

35. The secured article of claim 24 wherein the protecting layer comprises an obscuring layer.

36. The secured article of claim 35 wherein the obscuring layer comprises a scratch-off layer.

37. The secured article of claim 35 wherein the obscuring layer comprises a peel-off layer.

38. The secured article of claim 24 further comprising a print layer.

39. The secured article of claim 24 wherein the protecting layer comprises a multilayer film.

40. The secured article of claim 24 further comprising a thermochromic ink supported by the protecting layer or the adhesive layer.

41. The secured article of claim 24 wherein the protecting layer comprises a first sublayer and a second sublayer secured to each other along a peripheral edge to form a cavity, wherein secured information is disposed within the cavity.

42. The secured article of claim 41 wherein the first sublayer is the outermost layer and comprises an opaque scratch-off coating.

43. The secured article of claim 41 wherein the first sublayer is the outermost layer and comprises an opaque peel-off film.

44. The secured article of claim 35 wherein the obscuring layer is opaque to radiation selected from visible, infrared, ultraviolet, x-ray, and electron beam.

45. The secured article of claim 24 wherein the substrate comprises a material selected from paper, polymeric, glass, metal, ceramic, and cellulosic material.

46. The secured article of claim 24 wherein the substrate comprises a polymeric material selected from polyvinyl chloride, polyethylene, polyester, polypropylene, ethylene propylene diene terpolymer, polycarbonate, and polyolefin copolymers.

47. The secured article of claim 26 wherein the substrate is pretreated with a transition metal accelerator.

48. The secured article of claim 24 wherein the secured information layer comprises information selected from a personal identification number, an activation code, win/lose indicia, a barcode, a signature, RFID device, account numbers, and combinations thereof.

49. The secured article of claim 24 further comprising an adhesive curing agent, wherein the curing agent remains latent for a first period of time and is activated during a second period of time subsequent to the first period of time to cure the adhesive layer and permanently adhere the label to the substrate.

50. A method of producing a secure article, the article having a substrate having secured information supported thereon, the article comprising:
providing a label comprising an adhesive layer, the adhesive layer comprising a structural adhesive, wherein the adhesive layer is operable to adhere to the substrate upon application of the adhesive layer to a surface of the substrate with a bond strength of about equal to or about greater than a cohesive strength of the substrate or the adhesive layer;
overlaying the secured information with the label; and
permanently adhering the label to the substrate.

51. The method as defined in claim 50, the label further comprises a transparent film, the method further comprising allowing visual access to the secured information through the transparent film while blocking physical access to the secured information.

52. The method as defined in claim 50 wherein label further comprises an obscuring layer, the method further comprising selectively blocking visual access to the secured information using the obscuring layer until at least a portion of the obscuring layer is removed.

53. The method of claim 50 wherein the label further comprises a polymeric film adhered to the adhesive layer.

54. The method as defined in claim 53, further comprising pre-treating the substrate with a cure accelerator and orienting the polymeric film and the substrate to create a generally anaerobic environment, wherein the adhesive layer is disposed in the anaerobic environment.

55. The method as defined in claim 50, wherein the adhesive layer further comprises a pressure sensitive adhesive, and the adhesive layer is further operable to initially adhere to the substrate surface in response to light pressure.
